(19) United States
(12) Patent Application Publication
(10) Pub. No.: US 2010/0196081 A1
(43) Pub. Date: Aug. 5, 2010

(54) Coloring Apparatus

(76) Inventor: Terence William Bolton, West Sussex (GB)

Correspondence Address: Law Office of Michael D. Eisenberg;Intellectual Property Law, 3258 Caminito Eastbluff, Suite 89, San Diego, CA, 92037, US

(21) Appl. No.: 12/760,963

(22) Filed: Apr. 15, 2010

Related U.S. Application Data
(63) Continuation of application No. 10/592,369, filed on Jan. 29, 2007, now Pat. No. 7,726,896.

(30) Foreign Application Priority Data
May 11, 2004 (GB) 0410373.5
Sep. 6, 2004 (GB) 0419654.9

(51) Int. Cl. B43K 1/00

(52) U.S. Cl. 401/198

(57) ABSTRACT

An apparatus for enabling a liquid or dye to be conveyed from a nib of a source of liquid or dye to a fluid absorbent nib of a market pen. The apparatus includes a tubular docking member having the source and the nib of the source at a first end and an open portion at a second end configured to receive and engage an end of the marker pen including the nib of the marker pen selectively to be placed in contact with the nib of the source to cause liquid or dye to pass between the nib of the source and the nib of the marker pen. The liquid may comprise a translucent liquid such as water and the dye may comprise an indicator such as a water-based ink containing colored dyes, dispersed pigments or other coloring media.

### CROSS-REFERENCE TO RELATED APPLICATIONS

This application is a continuation of U.S. application Ser. No. 10/592,369 filed Sep. 11, 2006, which is a national stage application of PCT application serial number PCT/GB2005/001817 filed May 11, 2005 which claims priority from United Kingdom application serial number 0410373.5 filed May 11, 2004 and United Kingdom application serial number 0419654.9 filed Sep. 6, 2004 and are hereby incorporated herein by reference in the respective entirety of each.

### TECHNICAL FIELD

This invention relates to coloring apparatus. More especially, the invention relates to marker pens.

### BACKGROUND OF THE INVENTION

Typically marker pens comprise a tubular housing having a fibrous felt-like nib connected via a liquid absorbent wick to an internal chamber containing a fluid indicator such as a water-based ink which contains a colored dye (hereinafter referred to as a dye or colored dye for ease of understanding). As the marker pen is used the fibrous nib is replenished with ink which travels through the wick from the chamber by capillary action to the nib. Such pens are well known and are used inter alia to mark text and produce colored effects on paper or similar materials.

Generally, a marker pen is dedicated to producing a single color. If two or more colors are required, the same number of individual pens are normally required. Marker pens having more than one nib have been proposed, the intention of these being to produce two or more side-by-side colored lines with one stroke of a pen or a single line of a selected color. Such a marker pen is disclosed in WO 94/0997, WO 01/15912, U.S. Pat. No. 5,203,638, U.S. Pat. No. 3,887,287, UK-A-2277253. Marker pens are also known in which a finer nib can overlie a larger nib to enable a single pen to produce lines of different widths. Such pens are disclosed in EP-A-630326, U.S. Pat. No. 5,813,787 and U.S. Pat. No. 5,651,627. The Applicant's earlier application, PCT/GB2004/000859 discloses a marker pen having a casing including a fluid absorbent nib containing a liquid or dye of a first color, the interior of the casing being adapted to receive at least a portion of a reservoir pen having a fluid absorbent nib containing a liquid or dye of a second color which, when the reservoir pen is inserted into the open end of the casing, makes contact with the marker nib to allow donation of the second color to produce a color change in a single line or succession of such lines using the same marker pen.

### BRIEF SUMMARY OF EMBODIMENTS OF THE INVENTION

One object of the present invention is to provide alternative apparatus capable of enabling a marker pen consistently to produce in a line or succession of lines a uniform and consistent color change from one color to another color.

According to a first aspect, there is provided apparatus for enabling a liquid or dye to be conveyed from a source to a nib of a marker pen, the device comprising a docking member having an opening which is shaped and dimensioned to receive and engage with an end portion of a marker pen including the pen nib and to place the tip of the pen nib in contact with the source thereby enabling liquid or dye to flow from the source to the nib.

The liquid may comprise a translucent liquid such as water and the dye may comprise an indicator such as a water-based ink containing colored dyes, dispersed pigments or other coloring media. Alternatively, the colored dye may be oil-based.

In one arrangement, the source comprises another marker pen. In this arrangement, the docking member may comprise an open-ended hollow elongate tubular member with each open end shaped and dimensioned to fit over a collar of a marker pen.

In a second aspect, there is provided apparatus for conveying a liquid or dye from one marker pen to another, the apparatus comprising a tubular docking member having one end shaped and dimensioned to engage with an end portion of a first marker pen including the pen nib and the other end shaped and dimensioned to engage with an end portion including a nib of a second marker pen, the docking member being of such length that, when the end portions of the first and second member pens are engaged within the respective ends of the docking member the marker pen nibs make tip to tip contact, thereby enabling liquid or dye to pass therebetween.

In a third aspect, the invention provides coloring apparatus comprising a first marker pen having a housing including an absorbent nib containing a liquid or dye of a first color, and a second marker pen having a housing including an absorbent nib containing a liquid or dye of a second color, the housings of first and second marker pens being dimensioned and shaped to engage opposing end portions of a tubular docking member such that, in use, the absorbent nibs of first and second marker pens make contact with one another within the docking member.

The marker pen nibs may be produced from a fibrous material such as felt. Alternatively, one or each nib may be produced from a relatively inflexible material; a preferred material is that marketed under the trade mark POREX. This is a porous fluid retaining substance which holds its shape when applied to a surface in the manner of a marker to paper, card or like material. Other materials having similar physical properties may, however, be used.

In another arrangement, the source comprises a quantity of fluid absorbent liquid or dye containing wadding present within a docking member having at least one recessed opening shaped and dimensioned to engage with an end portion of a marker pen including a fluid absorbent nib, the dimensions of the or each docking member being such that when a marker pen is engaged within an opening the tip of its nib makes contact with the absorbent wadding to enable liquid or dye to flow to the marker pen nib.

In this arrangement, the recessed opening may be positioned at one end of a generally tubular casing, the other end of the casing being closed to retain the fluid absorbent wadding within the casing.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a side view of a marker pen and docking member constructed in accordance with a first embodiment of the invention;

FIG. 2 is a side view of the marker pen and docking member of FIG. 1 in one use;

FIG. 3 is a side view of the marker pen and docking member of FIG. 1 in a second use;

FIG. 4 is a side view of two marker pens combined with a docking member;

FIG. 5 is a side view partly in section of the two marker pens and docking member of FIG. 4;

FIG. 6 is a side view in section of a marker pen and docking member in accordance with another embodiment of the invention; and

FIG. 7 is a side view of two marker pens and a docking station in accordance with a further embodiment of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

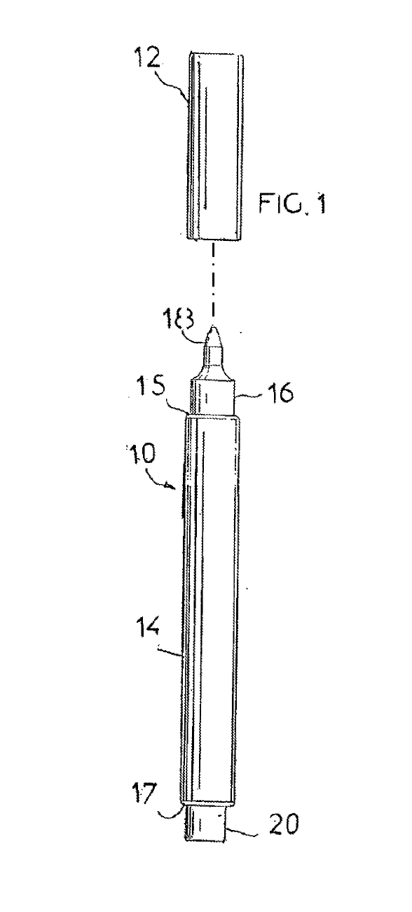

FIG. 1 illustrates a marker pen 10 and an open ended tubular docking member 12 in accordance with the invention. The marker pen 10 comprises an elongate generally tubular housing 14 having a collar 16 from which protrudes a fibrous felt-like nib 18 connected via a liquid absorbent wick (not shown) to an internal chamber (not shown) containing a fluid indicator such as a water-based ink which contains a colored dye (hereinafter referred to as a dye or colored dye for ease of understanding). A further collar 20 extends from the end of the marker pen remote from the nib 18. The entire pen structure 10 is generally cylindrical. Both collars 16, 20 are of the same diameter, which is less than the diameter of the pen housing 14. This difference in diameter causes upstanding annular abutment surfaces 15, 17 to be provided between the housing 14 and the collars 16, 20 respectively.

A removable cap 19 is provided to seal the absorbent nib 18 when the pen is not in use.

The docking member 12 comprises an open ended tubular member dimensioned to complement the dimensions of the marker pen 10. Consequently, in the case of a generally cylindrical pen 10 as described above, the docking member 12 is also generally cylindrical. The internal diameter of the docking member 12 is slightly greater than the outer diameter of the collars 16, 20 to enable the docking member 12 to engage with and over either collar 16, 20 until the end of the docking member 12 makes contact with the respective abutment surface 15, 17.

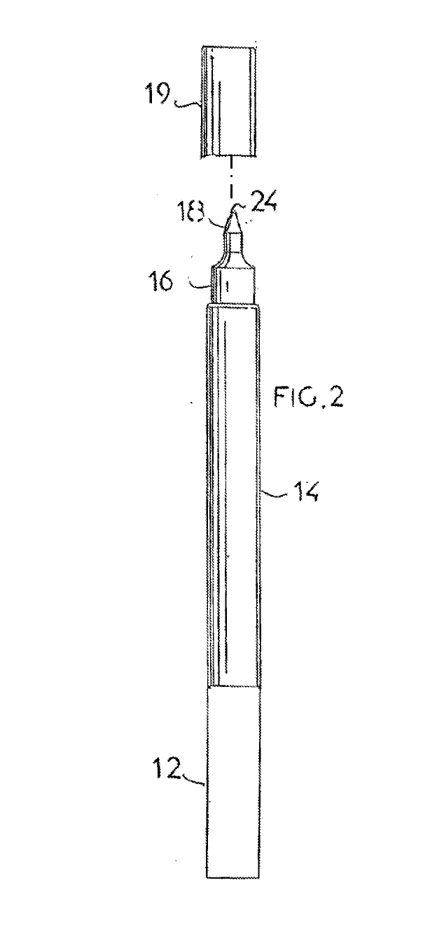

In the case of the docking member 12 engaging over the end collar 20, as shown in FIG. 2, the docking member 12 acts as an extension to the pen housing 14.

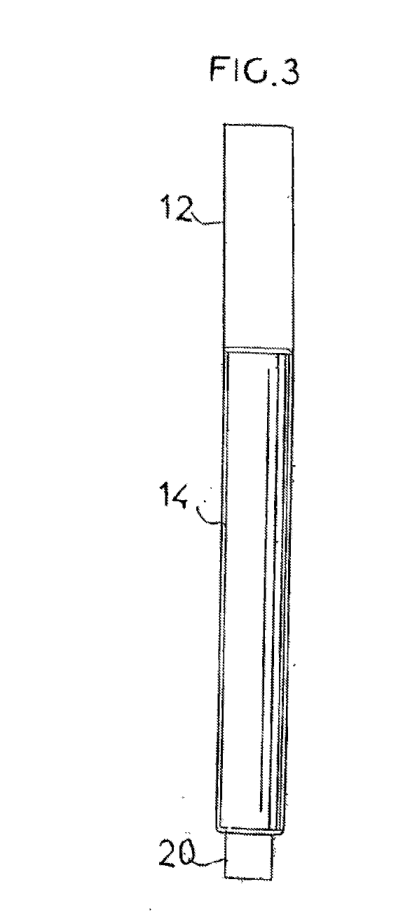

In the case of the docking member 12 engaging over the other collar 16 adjacent to the nib 18, as shown in FIG. 3, the docking member 12 acts as a cover to protect the nib 18.

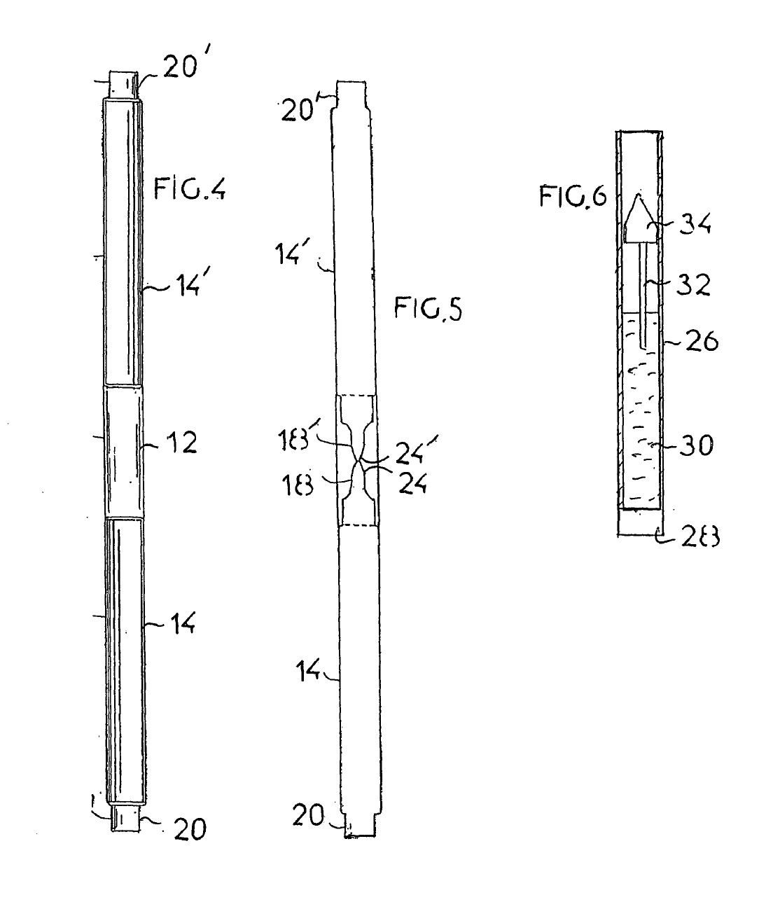

In the latter location, the docking member 12 also acts as a channel from one pen nib 18 to another, as will now be described with reference to FIGS. 4 and 5.

As shown, the length of the docking member 12 is equal to approximately twice the distance from the abutment surface 15 to the tip 24 of the nib 18 of the marker pen 10.

As already mentioned, this invention sets out to provide apparatus which enables a uniform and consistent color change to be produced in a line or succession of lines drawn by the nib of a single marker pen.

In order to provide such a consistent color change, one open end of the docking member 12 is first positioned over the collar 16 of the marker pen 10 with the end of the docking member in engagement with the abutment surface 15. In this position the nib 18 of the marker pen 10 extends approximately half-way into the docking member 12. A second marker pen 10′ containing a second dye of different color is then inserted nib-first into the other end of the docking member 12 until the respective end of the docking member makes contact with the abutment surface 15′. Because the length of the docking member 12 is approximately twice that of the collar 16 and nib 18 combined, the tips of the nibs 18, 18′ of each pen 10, 10′ just touch one another when the ends of the docking member 12 abut the respective ends of the housings 14, 14′ of the pens 10, 10′. The nib tip-to-nib tip contact achieved using the docking member 12 is important if a consistent color change in use is to be achieved.

The fact that the nib tips 18, 18′ touch one another allows a transfer of colored dye from nib 18′ of the second pen 10′ to the nib 18 of the first pen 10 when the pens are in contact. To effect this transfer, it is preferred that the second pen 10′ is held higher than the first pen 10. The docking member 12 acts to channel the dye from the second nib 18′ to the first nib 18 preventing leakage of the colored dye. The dimensions of the docking member are important to avoid damage to the nibs caused by excessive pressure being applied when the nibs come into contact and to ensure reproducible nib to nib contact for effective dye transfer.

Only a small period of time, for example five seconds, is required for sufficient dye to be transferred

Other color changes can, of course, be effected simply by appropriate selection of the original and donated colors. Thus, donated liquid may be, for example, water. In this arrangement, the line produced will essentially comprise an initially colored line which fades until it is transparent.

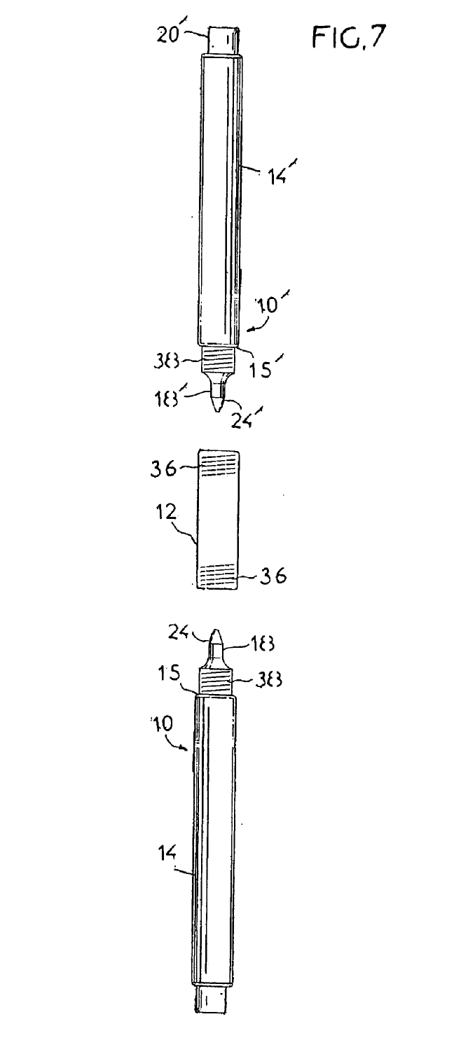

In a further embodiment illustrated in FIG. 7, the length of the docking member 12 is greater than twice the distance from the abutment surface 15, 15′ to the tip 24, 24′ of the nib 18, 18′ of each marker pen 10, 10′. Consequently, the nibs 18, 18′ of each pen 10, 10′ do not touch one another when both ends of the docking member 12 make contact with the abutment surfaces 15, 15′. In this embodiment though, one or both ends of the docking member 12 may have an internal thread 36 that receives an external thread 38 on one or both end portions of the pen housing 14. Once the docking member is engaged by the pens 10, 10′, one or each pen 10, 10′ is rotated to move the or each nib 18, 18′ further into the docking member 12 until the nibs 18, 18′ come into contact. Once the transfer of dye has taken place, the or each pen 10, 10′ is simply unscrewed to disengage the threads, and the pens 10, 10′ are simply pulled out of the docking member.

Instead of the removable cap 19, the end of the pen 10 may include a valve member, for example, in the form of a flexible diaphragm that is penetrable by the nib 18′ of the second pen 10′.

Turning now to the embodiment of the invention illustrated in FIG. 6, in which like integers to those illustrated previously have the same reference numerals, it will be seen that the docking member comprises a generally tubular housing 26 closed at one end by a removable plug 28 and open at its other end to receive the nib including end of the marker pen 10. A quantity of wadding 30 in which is absorbed a liquid or dye is positioned within the housing 26. The wadding 30 defines a source of liquid or dye and is transferred by capillary action using a wick 32 to an absorbent nib 34 positioned towards the open end of the tubular housing 26. The distance between the open end of the housing 26 and the nib 34 is such that, in use, the nib of a marker pen stationed within the recessed open end of the housing 26 makes point contact with the nib 34.

It will be appreciated that the foregoing is merely exemplary of marker pens in accordance with the invention and that various modifications can readily be made thereto without departing from the true scope of the invention described as set out in the appended claims.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. In addition, when a single callout line in the drawings leads to two or more separate reference numbers (first, second, etc. reference numbers) , (and each reference numeral refers to a different piece of text in the detailed description) and it would be inconsistent to designate the drawing item being called out as both pieces of text, the drawing be interpreted as illustrating two different variants. In one variant, the drawing item is referred to by the first reference number and in another variant the drawing item is referred to by the second reference number, etc.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. Apparatus for enabling a liquid or dye to be conveyed from a source to a nib of a marker pen, the device comprising a docking member having an opening which is shaped and dimensioned to receive and engage with an end portion of a marker pen including the pen nib and to place the tip of the pen nib in contact with the source thereby enabling liquid or dye to flow from the source to the nib.

2. Apparatus as claimed in claim 1 wherein the liquid comprises a translucent liquid.

3. Apparatus as claimed in claim 2 wherein the liquid comprises dye.

4. Apparatus as claimed in claim 1 wherein the dye comprises a water-based ink containing colored dyes, dispersed pigments or other coloring media.

5. Apparatus as claimed in claim 1 wherein the source comprises another marker pen.

6. Apparatus as claimed in claim 5 wherein the docking member comprises an open-ended hollow elongate tubular member with each open end shaped and dimensioned to fit over a collar of a marker pen.

7. Apparatus for conveying a liquid or dye from one marker pen to another, the apparatus comprising a tubular docking member having one end shaped and dimensioned to engage with an end portion of a first marker pen including the pen nib and the other end shaped and dimensioned to engage with an end portion including a nib of a second marker pen, the docking member being of such length that, when the end portions of the first and second member pens are engaged within the respective ends of the docking member the marker pen nibs make tip to tip contact, thereby enabling liquid or dye to pass therebetween.

8. Coloring apparatus comprising a first marker pen having a housing including an absorbent nib containing a liquid or dye of a first color, and a second marker pen having a housing including an absorbent nib containing a liquid or dye of a second color, the housings of first and second marker pens being dimensioned and shaped to engage opposing end portions of a tubular docking member such that, in use, the absorbent nibs of first and second marker pens make contact with one another within the docking member.

9. Apparatus as claimed in claim 1 wherein the source comprises a quantity of fluid absorbent liquid or dye containing wadding present within a docking member having at least one recessed opening shaped and dimensioned to engage with an end portion of a marker pen including a fluid absorbent nib, the dimensions of the or each docking member being such that when a marker pen is engaged within an opening the tip of its nib makes contact with the absorbent wadding to enable liquid or dye to flow to the marker pen nib.

10. Apparatus as claimed in claim 9 wherein the recessed opening is positioned at one end of a generally tubular casing, the other end of the casing being closed to retain the fluid absorbent wadding within the casing.

11. Apparatus as claimed in claim 9 wherein one or more recessed openings are set in the surface of a casing, each recessed opening being shaped and dimensioned to receive the nib end of a marker pen and including a quantity of liquid or dye.

12. Apparatus as claimed in claim 11 wherein the casing takes the form of a block having a generally flat under-surface.

13. Apparatus as claimed in claim 9 wherein the casing takes the form of a series of spokes radiating from a central hub, each spoke being open-ended to define a docking station for a marker pen.
